(19) United States
(12) Patent Application Publication
(10) Pub. No.: US 2007/0255763 A1
(43) Pub. Date: Nov. 1, 2007

(54) DATABASE REPLICATION METHOD AND SYSTEM

(75) Inventors: Marc Beyerle, Rottwell (DE); Achim Haessler, Gaeufelden-Nebringen (DE); Hoang-Nam Nguyen, Boeblingen (DE); Markus Nosse, Leonberg (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/681,808

(22) Filed: Mar. 5, 2007

(30) Foreign Application Priority Data
Apr. 27, 2006 (EP) 06113236.1

(51) Int. Cl. G06F 17/00

(52) U.S. Cl. 707/201; 707/E17.032

(57) ABSTRACT

A database replication method comprises storing a database snapshot to determine changes applied to at least one first database system component; generating a sequence of change records using the database snapshot, and rearranging the sequence of change records to reflect referential dependencies, and a database computer system, data processing program, and computer program product therefor.

### CROSS-REFERENCE TO RELATED APPLICATION

This application claims the priority benefit under 35 U.S.C. §119 of European application 06113236.1, filed Apr. 27, 2006, and incorporated herein by reference.

### BACKGROUND OF THE INVENTION

1. Field of the Invention

The invention relates to a database replication method and a database computer system, data processing program, and computer program product therefor.

2. Description of the Related Art

The process of copying and/or maintaining database objects in multiple databases that constitute a distributed database system is usually referred to as database replication. Changes applied at a first database are stored locally and are applied at another (remote) database upon synchronization request.

For this, a mechanism is implemented to create replicas of a relational database and to keep these created replicas in sync with each other. More specifically, in a system consisting of a server component (referred to as “server” in the following) and one or more client systems (referred to as “client” or “clients” in the following), it is required that a database hosted on the server (i.e. the server database) can be replicated to any client in the system, and that the replicated client databases can be kept in sync with the server database.

Some systems also support partial replicas, which are client databases being a real subset of the server database. For this, clients must be able to create partial replicas that can be kept in sync with the server database. Similarly, it is possible to augment existing partial replicas so that an augmented replica is a superset of the replica before augmentation and the augmented replica still is a subset of the server database. Supporting partial replicas increases complexity; an important consequence is that if allowing partial replicas, care must be taken not to violate referential integrity.

During operation, referential integrity constraints specified for the server database must not be violated by any (partial) replica, and partial replicas may overlap.

Current applications demand such systems to support a loose coupling between server and client components, where a multiplicity of clients can connect to access points of different servers over a network. Clients who are intermittently disconnected from the network still allow manipulation of their local database replicas.

For providing such systems, different solutions have been proposed.

SyncML is a set of standards which focus on (at least) two aspects of synchronization: synchronization protocol and synchronization representation protocol. SyncML specifies several synchronization modes such as full refresh, one-way sync, two-way sync, etc. For each mode, a sequence of messages is specified which have to be exchanged by the sync server and sync client. SyncML further specifies an XML-based language to exchange synchronization data. This standardized mark-up leverages synchronization of various sync clients with various sync servers.

DB2Everyplace by IBM Corp. is a solution consisting of a client database and a built-in synchronization mechanism allowing replication of a DB2 master database to client databases and vice versa. Content sets of client databases can be defined based on a set of filters by an administration tool. Client users can only replicate and synchronize this pre-defined set of data; no dynamic selection of replicated content is possible.

Changes of content sets are to be done by an “administrator”, and all replication requests are processed by a synchronization server asynchronously. Thus, no user triggered conflict resolution is supported.

IBM DB2 Replication is the built-in data replication solution for the IBM DB2 family of database management systems by IBM Corp. DB2 Replication uses a capture-and-apply mechanism to replicate relational data from one database table (referred to as the source table) to another (the target table). Multiple replication scenarios are supported, including unidirectional and bidirectional (peer-to-peer and update-anywhere). DB2 Replication allows vertical sub setting of the replication data (based on table columns), as well as horizontal sub setting (based on predicates, views and/or triggers). For the update-anywhere replication scenario, three conflict detection methods are provided: “none”, “standard” and “enhanced”. Scenario “none” does not detect any conflicts, whereas “standard” and “enhanced” always resolve a conflict in favour of the master. In contrast to “standard”, the “enhanced” conflict detection waits for all in-flight transactions to commit before checking for conflicts. For the peer-to-peer replication scenario, there is no conflict detection included in DB2 Replication. Referential constraints are kept by applying changes to the target tables in the same order in which the underlying transactions took place at the source tables (called transaction mode). In opposition to that, there is also a table mode for the apply phase, which does not take into account referential constraints, but issues a single commit after applying all changes of one apply cycle.

The principle of Transaction Log Replay is to capture operations that modify the data stored in the source database with help of log files that get written by the database. Only log files that contain synchronization-relevant modifications of data have to be captured. Synchronization of source and target database is then done by asynchronous application of the captured log files on the target database. Since log files get written by practically all databases to enable transactional protected data consistency, the concept of Transaction Log Replay can theoretically be used to implement a vendor-neutral synchronization. However, for the structure of database log files, database vendors use their own proprietary formats. Thus, an application would be closely tied to the used database system and additional coding would be required to make the synchronization solution usable for other database systems.

U.S. Pat. No. 5,758,337 proposes a system that provides replication for a partial replica database containing only those records desired by the user but also all the records necessary to maintain the referential integrity of the original database. The method described therein proposes to drop all referential constraints at the replica and to add them back when the partial replica is fully populated. Further, certain system tables are copied to the partial replica. Certain identifiers are copied to a temporary table, and each record is copied to the replica separately.

Patent application publication WO 97/35270 proposes an apparatus and a method that provides adaptable and configurable conflict resolution within a replicated data environment, wherein a conflict resolution module selects and activates a conflict resolution method from a range of such methods when a conflict is detected.

Consequently, it is an object of the present invention to provide a method for database replication, and a corresponding system and a corresponding computer program and computer program product, that are improved over the prior art and that allow the creation and synchronization of fully updatable, overlapping replicas as well as a fully updatable server database in a database platform-independent manner while reducing data traffic and memory space needed for synchronization and while still guaranteeing referential integrity.

### SUMMARY OF THE INVENTION

This object is achieved by the invention as defined in the independent claims. Further advantageous embodiments of the present invention are defined in the dependent claims.

The advantages of the invention are achieved by a database replication method comprising the steps of storing a database snapshot to determine changes applied to at least one first database system component; generating a sequence of change records using the database snapshot; and rearranging the sequence of change records to reflect referential dependencies.

By storing a database snapshot, the state of a database at a certain point of time can be reliably determined, and changes applied to the database can be reliably tracked. Furthermore, the database snapshot provides the data basis that is specifically suited to derive a minimal list of change records in a particularly efficient manner.

By generating a sequence of change records, a minimal list of change data is produced that provides the basis for comparing and/or updating the processed database with another database. Thus, storage and data communication capacity needed for comparing and/or updating is dramatically reduced and the change records are generated in a platform-independent manner. For instance, the sequence of change records can be produced with a standardized query language and then chronologically sorted regarding their update point of time. In this way, local changes to the database are performed in the same order on another database when the two databases are synchronized with each other.

By rearranging the sequence of change records to reflect referential dependencies, it is guaranteed that, when change records are processed according to the rearranged sequence, referential integrity is maintained at any time in the process while enabling to use the minimal list of change records. A minimization is achieved by coalescing (or compacting) database operations on the same record into a single operation. The order of operations on two dependent records is crucial to referential integrity, but may get lost by this compaction of operations. The topologic sort ensures the correct order of such coalesced operations on dependent records.

Thus, the method according to the present invention allows comparing or synchronizing replicated databases in a platform-independent and highly resource-effective manner while stably maintaining referential integrity throughout the entire process.

In one embodiment of the invention a database computer system is configured to perform the database replication method and comprises a database and a replication engine accessing the database.

By having a replication engine, the database computer system provides means to monitor data manipulation performed on the database and update a data snapshot respectively, means to determine changes having been applied and generate a sequence of change records that is rearranged to reflect referential dependencies.

Further, additional embodiments can be carried out following the dependent claims and are explained below.

In one embodiment, the method described above further comprises transmitting the rearranged sequence of change records to a second database system component, and applying changes to the second database system component corresponding to the rearranged sequence, thus fully updating the second database component.

In a further embodiment, storing the database snapshot comprises storing a snapshot definition record and at least one snapshot data record. As well, the method can comprise updating the database snapshot on the condition of changes being applied to the first database system component.

In order to generate change records, an embodiment comprises selecting those data records for which no entry exists in the database snapshot and/or selecting those data records for which an entry exists in the database snapshot that has been updated and/or selecting those elements of the database snapshot for which no data record exists. Another embodiment comprises creation of a change record for those data records for which no entry exists in the database snapshot and creation of a change record for those data records for which an entry exists in the database snapshot that has been marked as updated and creation of a change record for those elements of the database snapshot for which no data record exists.

Generating a sequence of change records can comprise sorting them in the chronology of the changes applied. Further, rearranging the sequence of change records can, in different embodiments, comprise, while traversing change records, skipping a change record on the condition of the change record indicating a delete operation, skipping a change record on the condition of the change record indicating an insert or update operation of a first data record referencing a second data record and the database snapshot having an entry for the second data record, and selecting a change record and placing a change record of a second data record before the selected change record on the condition of the selected change record indicating an insert or update operation of a first data record referencing the second data record and the database snapshot having no entry for the second data record and the change record of the second data record not being a predecessor of the change record of the first data record, while performing this recursively on the referenced record.

In a further embodiment, conflicts between changes applied to the at least one first database system and changes applied to the second database system component are detected, and can be entirely performed on the second database system component.

In an embodiment comprising steps at two or more components in a distributed environment with a second database system component, the method can be carried out in that a second database snapshot and a second sequence of change records is generated on the second database system component and, for each change record of the first sequence of change records, it is determined if a corresponding change record of the second sequence of change records exists that refers to the same data record. Further, an embodiment is possible in which values of change records of the first sequence of change records are compared to values of corresponding change records of the second sequence of change records that refer to the same data record.

The invention and its embodiments will be further described and explained using several figures.

### BRIEF DESCRIPTION OF THE DRAWINGS

FIG. 1 is a block diagram showing a system overview comprising a possible configuration in use;

FIG. 2 is a flow diagram giving an overview of an embodiment of the invention;

FIG. 3 is a block diagram showing an implementation of a snapshot data structure;

FIG. 4 is a sequence-type diagram showing message flow between a first and a second database system component;

FIG. 5 is a flow diagram showing a detail of generating a sequence of change records; and

FIG. 6 is a flow diagram showing a detail of rearranging the sequence of change records to reflect referential integrity.

### DETAILED DESCRIPTION OF THE INVENTION

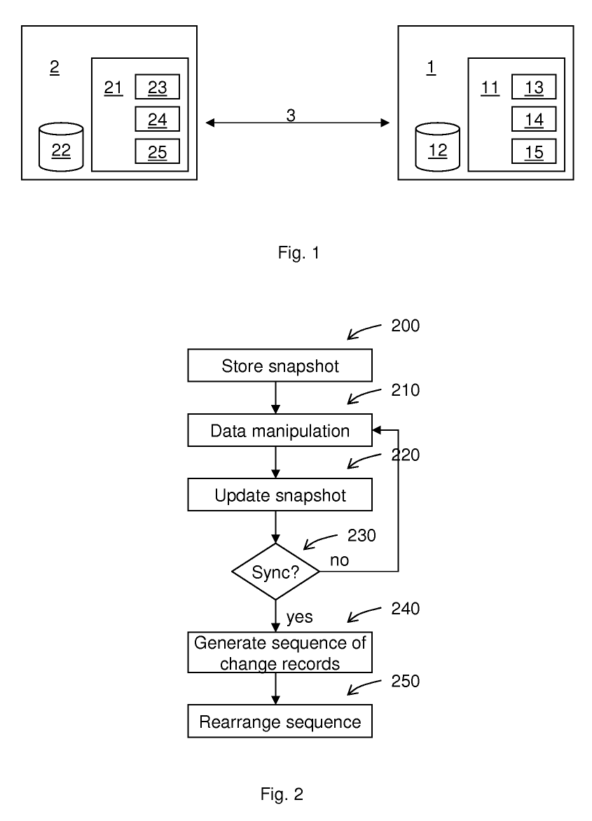

FIG. 1 is a block diagram showing a system overview comprising the configuration of a typical embodiment in use. A client 2 comprises (or is coupled to) a local (client) database 22 and a replication engine 21, which in turn comprises subcomponents change capturing 23, change detection 24 and a stored replication scheme 25. Server 1 is configured similarly, with local (server) database 12, replication engine 11, subcomponents change capturing 13 and change detection 14, and a stored replication scheme 15. Databases 12 and 22 are replicated, and server 1 and client 2 communicate over data channel 3.

Change capturing component 23 is responsible for monitoring data manipulation performed on database 22, which is triggered from the application. For this, the application notifies replication engine 21 of the data change applied using predefined application programming interface (API) calls.

Change detection component 24 is responsible for determining changes applied to database 22 and for generating and delivering a minimal list of change records that can be applied to a target database, such as database 12, without violation of referential integrity.

Stored replication scheme 25 provides a description of replicated tables and data. It particularly contains information about tables and relationships between them. An exemplary replication scheme is embodied as follows:

| Table | References/Contains |
|---|---|
| Student | |
| Teacher | |
| Course | Teacher, Course |
| Class | Student |

The column Table indicates the tables to be considered. The column References defines the containment relationships of the table designated by column Table. Furthermore, each table defined in the replication scheme should comprise a primary key so that each record can be identified uniquely.

Operation of replication engine 21 (and 11, respectively) and its subcomponents is shown in FIG. 2 in more detail.

In step 200, a data snapshot is created and/or stored. This is typically performed when a replica 22 is newly created or synchronized (whichever occurred more recently). A snapshot defines a set of records that serves to recognize changes that have been applied since the last synchronization (or creation) point. Details of the data snapshot are discussed later referring to FIG. 4.

While using the database 22 (or 12), a user manipulates data stored in the database in step 210. As pointed out above and shown in step 220, replication engine 21 is notified of the data change applied using predefined application programming interface (API) calls in order to keep the database snapshot up-to-date. This can be done by application software or middleware which uses the replication and synchronization mechanism of the present invention. For this, certain APIs are provided to access functionality of the mechanisms described by this invention.

Thus, if a record is updated on the server 1 or the client 2, the application calls the appropriate API which updates the fields “last updated timestamp” and “last updated version number” of the corresponding snapshot data record. If a record is added or deleted on the server 1 or the client 2, nothing needs to be recorded, since those operations are recognized by checking the existence respective non-existence of a record with a database query statement as shown with regard to step 240 below.

When synchronization (or, a mere data comparison, respectively) is to be performed, which is determined in step 230, a minimal sequence of change records is generated in step 240. In this case, client 2 first scans its own snapshot data table for local changes, resulting in change records. Only these will be sent to the server after being sorted as described below, for instance as a parameter of a replication request or for a data comparison.

Similarly, as will be shown referring to FIG. 4, also server 1 sends only those records that have been changed on the server back to the requesting client 2.

The result is a minimal list of change record objects, i.e. each changed data record is represented by exactly one change record, comprising the following content fields:

| | |
|---|---|
| Operation | database operation to be performed, can be one of |
| | insert, update or delete |
| Record id | primary key of the record that has been changed |
| | and needs to be synchronized |
| Record fields | if operation is insert or update, the whole record to |
| | be synchronized on the target database |
| Last updated | timestamp of the most recent update |
| timestamp | |
| Last updated | version number of the most recent update |
| version-nr | |

In an implementation, also the table name can be included in the change record, depending on how unique the record id is.

Next, in step 240 this list is chronologically sorted, that is, sorted by the “last updated timestamp” in ascendant order. This is because the local changes should be performed in the same order on the target database as they have been executed on the local database. For performing this sorting operation, a stable sorting method is preferred.

At this point a sequence of change records of local changes sorted by the last updated timestamp is obtained. Now, this sequence is rearranged to reflect/maintain referential dependencies. Thus, in order to assure referential integrity when applying that list to a target database, for instance database 12 of server 1, in step 250 the topology of each record is considered and the change records are rearranged in such a way that they can be applied following the order of the rearranged sequence without any violation against defined relationships. This process of rearranging is referred to as topological sorting and is shown in more detail in FIG. 6 further below.

Finally, the sequence of change records can be sent to a second database system component such as from client 1 to server 2 (or vice versa). In one application scenario, a server having received the list may examine each change record for an update conflict with its local changes, as will be described further below.

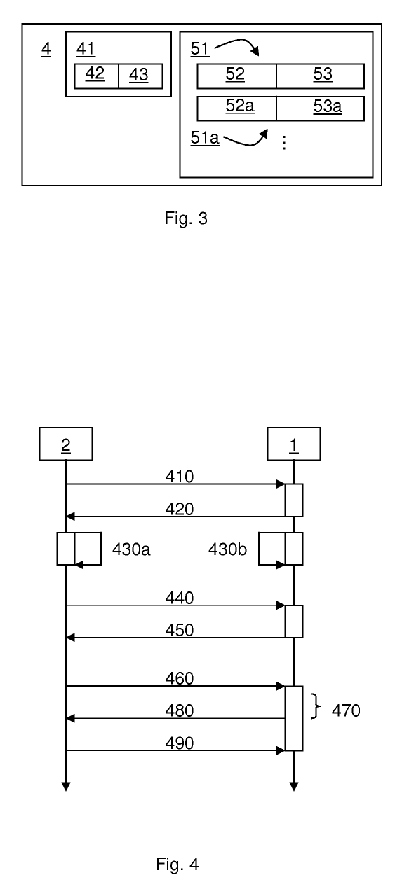

The structure of a data snapshot 4 is shown in FIG. 3. In order to recognize changes that have been applied since the last synchronization point, a snapshot definition 41 and snapshot data 51 is stored for each client 2, for instance, by server 1.

Referring to the overall system, each client stores its own snapshot, and the server stores the snapshots for all its clients.

Snapshot definition 41 defines which types of replica a client 1 has requested (or contains) and the timestamp of the last synchronization point. In a full embodiment, snapshot definition 41 can contain a snapshot definition id, a client id (such as IP-address and client name), a replica type 42 and a last synchronization timestamp 43.

Snapshot data 51 contains a snapshot data record 51 for each record that was replicated to the client. Snap shot data record 51 comprises a data record identifier 52, such as record id and table name, and a version tag 53, such as a last updated timestamp and version number. Any modification of the corresponding record will also update the version tag appropriately. In a full embodiment, a snapshot data record consists of the following fields: snapshot definition id, record id (such as the primary key of the replicated record), table name, synchronization timestamp, synchronization version number, last updated timestamp, and last updated version number.

To ensure that any modification of a data record will also update the version tag of the corresponding snapshot data record, the application should make an explicit API call.

For some applications of the principle of the present invention, each client maintains its own snapshot definition and data as described above.

To illustrate a typical scenario wherein the present invention is shown producing its advantageous effects at two distinct points, namely with performing a mere data comparison and with performing a data synchronization between a client and a server, FIG. 4 shows a sequence diagram of a typical conversation sequence between a client 2 and a server 1.

In step 410, client 2 submits a request to create a data snapshot. Server 1 stores snapshot information as described above in its database in order to track local changes and detect update conflicts. In step 420, server 1 then returns a list of change records to client 2. Client 2 applies them to its database and has then the same data content like the server database.

Referring to steps 430a and 430b, it is shown that users can manipulate the data on both the client and the server concurrently and independently.

In step 440, client 2 submits a data compare request to server 1, together with a sequence of change records. Server 1 determines its local changes, compares them against the client's changes and determines possible update conflicts. Server 1 returns the result to the client in step 450. Client 2 can show the update conflicts to the user and lets them decide which version to be favored during an actual synchronization.

In step 460, client 2 determines its local changes and submits a synchronization request to server 1, together with the sequence of change records. Server 1 determines first its local changes and compares them against the client's change records in order to check if any update conflicts exist in step 470. If no update conflicts are found, server 1 applies the changes received from the client to the server database, and then sends or returns its local changes to client 2 in step 480. As a result, client 2 applies the server change records to its database. In step 490, client 2 sends an acknowledgement message to server 1.

This scenario may take place with a multiplicity of clients as well. When the server applies changes of the client, a clean rollback of synchronization is always possible if there is a failure. When the client applies server changes, based on the two-phase commit described above, the server is able to cleanly roll back the snapshot data of the client of a previous state such that the client may recover its local data after a failure during this phase.

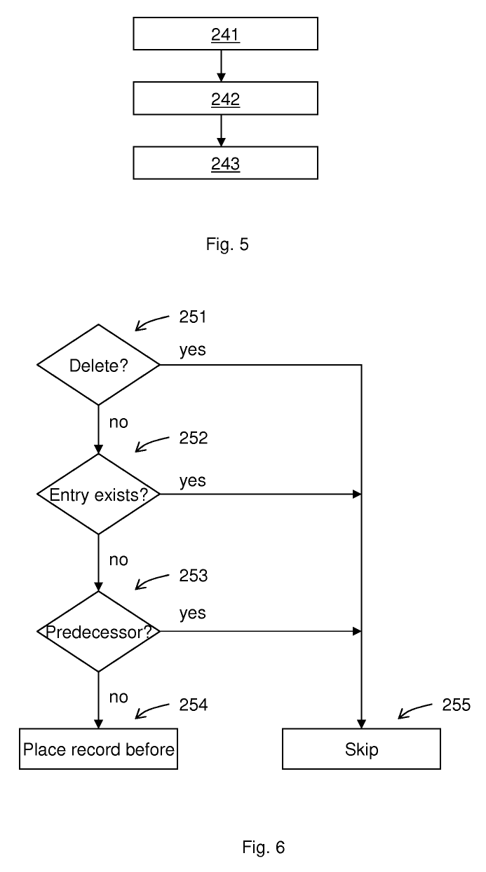

FIG. 5 shows in detail how the calculation of local changes is performed. In step 241, for each table defined by the replication scheme, the SQL select statement below delivers the records that have been added on the client or server, as the case may be:

SELECT * FROM <table> WHERE ID NOT IN
(SELECT RECORDID FROM SNAPSHOTDATA S WHERE
S.TABLENAME=<table>)

In step 242, for each table defined by the replication scheme, the SQL select statement below delivers the records that have been updated on the client or server, as the case may be:

SELECT * FROM <table> WHERE ID IN
(SELECT RECORDID FROM SNAPSHOTDATA S WHERE
S.TABLENAME=<table> AND S.lastupdatedversionnr is not null
AND S.lastupdatedversionnr>S.syncversionnr)

In step 243, for each table defined by the replication scheme, the SQL select statement below delivers the records that have been deleted on the client or server, as the case may be:

SELECT RECORDID FROM SNAPSHOTDATA S WHERE
S.TABLENAME=<table> AND S.recordid is not in
(SELECT ID from <table>)

By calculating the union of these three result lists, the total list of all changed records is determined.

FIG. 6 shows how the topological sorting of the sequence of change records is performed. The list of change records is traversed and the following steps are performed for each list item:
1. If, in step 251, a change record indicates a record to be deleted, skip and continue with next change record, step 255.
2. If a record, which is either to be inserted or updated, has a containment-relationship to another record as defined by the replication scheme, assure that the referenced record exists. Two scenarios may occur:
   A. The referenced record exists in the Snapshot data table, as determined in step 252, i.e. the change records field operation is update. That means the referenced record also exists on the target database. Thus referential integrity is not violated when this change record is applied. So skip and continue with the next change record, step 255.
   B. The referenced record is not found in the Snapshot data table, step 252. That means it has been added locally, i.e. the change records field operation is insert. In this case we need to assure that the change record associated with the referenced record will be visited, i.e. applied on the target database before the current change record. That means we need to move the referenced change record to the position just before the current change record. If the referenced record is a predecessor of the current one, determined in step 253, nothing has to be done, step 255.
      Note that this reordering needs to be performed recursively, i.e. this rule is applied to each referenced record.
3. Continue with step 1 for next change record.

The usage of “predecessor” in this case refers to the order of change records in the minimal list of change records after this list has been sorted chronologically: If the second change record appears in this list before the first change record, it is considered to be a predecessor.

The recursive behavior is as follows: If the second change record is placed before the first change record, the rearranging is done recursively for the second change record. After the recursion has ended, traversal continues with the change record now following the first change record in the list.

As an example, consider the chronologically sorted list of change records (first, third, second, fourth), where the first record references the second, and the second references the third. When the traversal reaches the first record, the second is placed before the first, which gives an intermediate result in which second would be applied before third, contradicting the reference from second to third. This intermediate result is corrected by the recursion on the second record, which moves the third record before the second. Then traversal continues on the fourth record.

In an illustrative example of the result of topological sorting, consider a sequence of change records that has already been sorted chronologically regarding the last update timestamp, showing three insertions of records:

| Operation | Record | Timestamp |
|---|---|---|
| Insert | B | 2 |
| Insert | C | 3 |
| Insert | A | 4 |

Using the replication scheme in order to determine that “B is dependent on A”, a topological sort as described above results in the following order:

| Operation | Record | Timestamp |
|---|---|---|
| Insert | A | 4 |
| Insert | B | 2 |
| Insert | C | 3 |

Insertion of record A must take place before insertion of record B, otherwise referential integrity would be violated.

In one embodiment, conflict detection is executed mainly on the server after a client request with its list of change records comes in. In this case, no conflict detection is required on the client, since the present invention guarantees that the list of change records returned from the server as a result of a synchronization request will be applicable to the client's database.

First the server determines the list of its change records as described above. In the following the terms “client change record” and “server change record” are used to designate a change record originated from the client and the server respectively. Next the following steps will be performed for each client change record, and the result is a list of update conflict record, which is initially empty:
1. If there is no server change record with the same primary key, which means that the associated data record has not been modified by any database operation on the server since the last synchronization point, continue with the next client change record.
2. If the operation field of both client and sever change record is DELETE, continue with the next client change record. Note that this is not a conflict, even though the same data record was deleted by both the client and server since the last synchronization point.
3. If the update_hint field of client change record is OVERWRITE, remove the corresponding entry from the list of change records the server calculated above to prevent it being returned to the client. Continue with the next client change record.
4. If the operation field of either client or server change record is DELETE, which means the operation field of the counterpart is either INSERT or UPDATE, create an update conflict entry bound to the server change record and put it into the list of update conflicts. Continue with the next client change record.
5. At this point the operation field of both client or server change record is either INSERT or UPDATE. If the associated data fields are equal, remove client change record. This causes the server version overwriting the client's one. Continue with the next client change record.
6. At this point the operation field of both client or server change record is either INSERT or UPDATE and the associated data fields contain unequal values. Create an update conflict entry bound to the server change record, put it into the list of update conflicts and continue with the next client change record.

If the list of update conflicts is empty at this point, this means no conflict was detected and the client change records can be applied to the server database. The server change records will be returned to the client as a result of its synchronization request.

The automatic resolution of update conflicts provided by an embodiment of the present invention is that the server version will be preferred if and only if both records are equal in term of their field values, i.e. only their version numbers may be different. However a client can utilize the change records field update_hint to enforce which version is more accurate. Below is a procedure a client performs for a user-controlled conflict resolution:
1. Send request to server to compare local changes against server database.
2. If the result returned by the server does not contain any conflicts, local changes can be applied by a subsequent synchronization request.
3. If any conflicts are returned by the server, show the found conflicts to the user and let her/him decide which version of each conflict is to write into the server database. Send a synchronization request with local change records with appropriate update_hint flag.

To create a replica, in addition to the techniques described above with regard to steps 410 and 420, the following is to be considered. On the server, those data records which should be included in the content set of the replica should be determined. The content of the replica is determined by the filters which are defined by the user, and by the references as specified in the replication scheme. The records in the content set must both match the filters of the user, and satisfy all referential constraints. To construct the minimal content set which satisfies these two conditions, for each of the data records a change record is created with its operation being “insert”, then change records are ordered chronologically according to creation time stamp (if no creation timestamp is available, this step may be skipped), and then change records are rearranged to reflect referential dependencies (topological sorting). On the client, the list of received change records is applied in the same way as in the case of synchronizing, and a snapshot is stored to track local changes.

Creating a replica can thus be summarized to these steps: determine the content set, create change records for each record in this set with operation=insert and store the snapshot data. Then these change records are sent to the client and processed by the same method as when synchronizing.

The invention can take the form of an entirely hardware embodiment, an entirely software embodiment or an embodiment containing both hardware and software elements. In an embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read-only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

To avoid unnecessary repetitions, explanations given for one of the various embodiments are intended to refer to the other embodiments as well, where applicable. In and between all embodiments, identical reference signs refer to elements of the same kind. Moreover, reference signs in the claims shall not be construed as limiting the scope. The use of “comprising” in this application does not mean to exclude other elements or steps and the use of “a” or “an” does not exclude a plurality. A single unit or element may fulfill the functions of a plurality of means recited in the claims.

### LIST OF REFERENCE NUMERALS

1 Server system

2 Client system

3 Data communication channel

4 Snapshot data structure

11 Replication engine

12 Database

13 Change capturing component

14 Change detection component

15 Stored replication scheme

21 Replication engine

22 Database

23 Change capturing component

24 Change detection component

25 Stored replication scheme

41 Snapshot definition record

42 Replication type indicator

43 Synchronization timestamp

51, 51a Snapshot data record

52, 52a Data record identifier

53, 53a Version tag

200 Store snapshot

210 Data manipulation

220 Update snapshot

230 Synchronization request occurred?

240 Generate sequence of change records

241 Select data records

242 Select data records

243 Select data records

250 Rearrange sequence of change records

251 Is operation “delete”?

252 Does database snapshot have an entry for the second data record?

253 Is change record a predecessor?

254 Place record before current record

255 Skip record

410 Request to create snapshot

420 Snapshot data/change records

430a, 430b Manipulate data on database

440 Compare request

450 Result data/update conflicts

460 Synchronization request

470 Apply changes

480 Result data/server changes

490 Acknowledge synchronization

What is claimed is:

1. A database replication method, comprising the steps of:
storing a database snapshot to determine changes applied to at least one first database system component;
generating a sequence of change records using the database snapshot; and
rearranging the sequence of change records to reflect referential dependencies.

2. A method according to claim 1, further comprising the steps of:
transmitting the rearranged sequence of change records to a second database system component; and
applying changes to the second database system component corresponding to the rearranged sequence of change records.

3. A method according to claim 2, wherein conflicts between changes applied to the at least one first database system component and changes applied to the second database system component are detected.

4. A method according to claim 3, wherein conflict detection is entirely performed on the second database system component.

5. A method according to claim 3, wherein the database snapshot is a first database snapshot and the sequence of change records is a first sequence of change records, and wherein a second database snapshot and a second sequence of change records are generated on the second database system component and, for each change record of the first sequence of change records, it is determined if a corresponding change record of the second sequence of change records exists that refers to the same data record.

6. A method according to claim 5, wherein values of change records of the first sequence of change records are compared to values of corresponding change records of the second sequence of change records that refer to the same data record.

7. A method according to claim 1, wherein storing the database snapshot comprises storing a snapshot definition record and at least one snapshot data record.

8. A method according to claim 1, comprising updating the database snapshot on the condition of changes being applied to the first database system component.

9. A method according to claim 1, wherein generating a sequence of change records comprises selecting data records for which no entry exists in the database snapshot.

10. A method according to claim 1, wherein generating a sequence of change records comprises selecting data records for which an entry exists in the database snapshot that has been updated.

11. A method according to claim 1, wherein generating a sequence of change records comprises selecting elements of the database snapshot for which no data record exists.

12. A method according to claim 1, wherein generating a sequence of change records comprises sorting them in the chronology of the changes applied.

13. A method according to claim 1, wherein rearranging the sequence of change records comprises, while traversing change records, skipping a change record on the condition of the change record indicating a delete operation.

14. A method according to claim 1, wherein rearranging the sequence of change records comprises, while traversing change records, skipping a change record on the condition of the change record indicating an insert or update operation of a first data record referencing a second data record and the database snapshot having an entry for the second data record.

15. A method according to claim 1, wherein rearranging the sequence of change records comprises, while traversing change records:
a. selecting a change record;
b. placing a change record of a second data record before the selected change record on the condition of the selected change record indicating an insert or update operation of a first data record referencing the second data record and the database snapshot having no entry for the second data record and the change record of the second data record not being a predecessor of the change record of the first data record; and
c. performing steps a and b recursively on the referenced record.

16. A database computer system configured to perform the steps according to the method of claim 1, comprising a database and a replication engine accessing the database.

17. A database computer system according to claim 16, wherein the replication engine comprises a change capturing component and change detection component, and wherein further a replication scheme is stored.

18. A data processing program for execution in a data processing system comprising software code portions for performing a method according to claim 1 when said program is run on said computer.

19. A computer program product stored on a computer usable medium, comprising computer readable program means for causing a computer to perform a method according to claim 1 when said program is run on said computer.
